(19) United States
(12) Patent Application Publication
(10) Pub. No.: US 2006/0242903 A1
(43) Pub. Date: Nov. 2, 2006

(54) Apparatus for use for methane oxidation

(76) Inventors: Maxim Lyubovsky, North Haven, CT (US); Subir Roychoudhury, Madison, CT (US); Andrew Heeps, Farmington, CT (US)

Correspondence Address: Precision Combustion, Inc., 410 Sackett Point Road, North Haven, CT, 06473, US

(21) Appl. No.: 11/476,995

(22) Filed: Jun. 27, 2006

Related U.S. Application Data
(62) Division of application No. 10/178,130, filed on Jun. 24, 2002, now abandoned.

(51) Int. Cl. B01J 8/00

(52) U.S. Cl. 48/127.9

(57) ABSTRACT

The invention provides an apparatus for the combustion of methane. The apparatus promotes the reformation of methane and oxygen in fuel-rich proportions into carbon monoxide and hydrogen and residual methane. The carbon monoxide, hydrogen and residual methane is then combined with oxidant in fuel lean proportions to continue oxidation in a porous media that absorbs some of the heat of oxidation and radiates the heat as infrared radiation.

### CROSS-REFERENCE

This application is a divisional application of U.S. patent application Ser. No. 10/178,130; filed Jun. 24, 2002, and incorporated herein by reference.

### FIELD OF THE INVENTION

The present invention is generally directed to catalytic combustion, and more specifically to an apparatus for use therewith for the reformation of methane into partial oxidation products and the oxidation of those products at a temperature below the adiabatic temperature thereof.

### BACKGROUND OF THE INVENTION

Methane is an abundant hydrocarbon that is used as a source of fuel in numerous applications, such as industrial radiant heaters, gas turbines, home furnaces and cooking equipment. While methane can be made available in a relatively pure form, it is more commonly provided as a constituent of natural gas, of which it is the primary component.

Natural gas is typically combusted in an open flame, a process referred to as diffusion burning, which generates certain pollutants. One particularly undesirable class of pollutants formed during diffusion burning is nitrous oxides, i.e. NOx. In diffusion burning, NOx can be formed by any one of three possible mechanisms: thermal, prompt, and fuel bound. The production of NOx by the thermal and the prompt mechanisms, however, far exceeds that produced from the fuel bound mechanism. Consequently, efforts to reduce NOx pollution focus on reducing NOx formation by the thermal and/or the prompt mechanisms.

NOx produced by the thermal mechanism, i.e. thermal NOx, is often the dominant mechanism. Thermal NOx is formed when the heat being released by diffusion burning is sufficient to provide the necessary energy for the nitrogen in the air to combine with the oxygen in the air. Generally, at flame temperatures below 1700 K, the production of thermal NOx is insignificant. However, as flame temperatures increase, the production of thermal NOx increases sharply.

Thermal NOx production can be controlled by regulating reactant stoichiometry. To burn a fuel it must be mixed with an oxidant. For example, in order to burn methane, oxygen must be provided. The ratio of the fuel and oxidant, that is methane and oxygen, is the reactant's stoichiometry. Reactant stoichiometry is expressed in terms of a fuel/oxidant equivalence ratio, or where the oxidant is oxygen as a constituent of air—fuel/air ratio. The fuel/oxidant equivalence ratio is the ratio of the actual fuel/oxidant ratio to the stoichiometric fuel/oxidant ratio. For example in the case of methane (CH₄), the combustion reaction is CH₄+2O₂→CO₂+2H₂O. Therefore, a stoichiometric fuel/oxidant ratio is one part CH₄ and two parts O₂. Thus, if a mixture had this ratio of CH₄ and O₂, the reactant stoichiometry as expressed by the fuel/oxidant ratio of the mixture would be 1.0 (an actual mixture having these proportions would be referred to as stoichiometric).

A mixture having an equivalence ratio greater than 1.0 is fuel rich (i.e., in the case of the above methane reaction, more than one part fuel for each two parts of oxygen), and a mixture having an equivalence ratio less than 1.0 is fuel lean (i.e., in the case of the above methane reaction, less than one part fuel for each two parts of oxygen). When combustion is adiabatic, stoichiometric mixtures burn relatively hotter than non-stoichiometric mixtures and the further away the mixture is from stoichiometric the relatively cooler it burns.

NOx production by the prompt mechanism, i.e. prompt NOx, is a fuel-rich, gas-phase phenomenon. The reaction is quick and completes within the diffusion flame. The production of NOx by the prompt mechanism can only be controlled if the diffusion flame is eliminated, in whole or in part.

NOx formation from the combustion of methane could be greatly reduced if methane could be combusted at temperatures below 1700 degrees K and diffusion flame could be avoided. It is well known in the art that if methane is catalytically combusted, i.e. oxidized in the presence of a catalyst, the energy within the methane can be released without the formation, or limited formation, of thermal and/or prompt NOx.

A problem, however, with the catalytic combustion of methane is that methane is a very stable molecule. Thus, it is more difficult to oxidize than higher order hydrocarbons, such as propane. Methane can be catalytically combusted under fuel lean conditions producing combustion temperatures below 1700 degrees K. When a palladium-based catalyst is used the reaction may become unstable due to properties of Pd—PdO transformation of the catalyst. Hysteresis in the catalyst activity makes controlling the reaction extremely difficult. Platinum based catalysts on the other hand can provide more stable operation. However, volatility of Pt at the desired temperatures under lean conditions is very high. Thus, platinum catalyst lacks durability.

Based on the foregoing, it is an object of the present invention to develop an apparatus for the combustion of methane that overcomes the problems and drawbacks associated with the prior art.

### SUMMARY OF THE INVENTION

The present invention is directed to an apparatus for the combustion of methane. A fluid stream including fuel having methane and oxygen that is in fuel rich proportions, i.e. having a fuel/oxidant equivalence ratio greater than 1.0, is provided. The fluid stream flows into a reformation reactor having a catalyst therein that promotes the reformation of methane (CH₄) into carbon monoxide (CO) and hydrogen (H₂).

The catalyst reforms at least a portion of the methane in the fluid stream into carbon monoxide and hydrogen creating an exhaust stream exiting the reformation reactor having various fuel constituents therein, such as unreformed methane, CO and H₂. The exhaust stream is then divided into a plurality of exhaust streamlets by passing the exhaust stream into a manifold having a plurality of discrete discharges. As a portion of the exhaust gas exits through a discharge, an exhaust streamlet is formed. Sufficient oxygen is then added to the exhaust streamlet such that the fuel constituents therein and the oxygen are in fuel-lean proportions. Same amounts of oxygen should be added to each streamlet, such that variations in the equivalence ratios between the streamlets are small. The exhaust and second fluid are added together, not mixed.

In the present invention, it is desired that the exhaust and the second fluid enter the porous media as distinct flow steams. It is understood however, that the two fluids will be in contact along an interface and that incidental diffusion of one fluid into another will occur. It is expected that if sufficient time is provided, the diffusion combustion would occur at the interface before the two streamlets can mix. To avoid gas phase flame oxidation of the exhaust stream, which is undesirable in this invention, the combined stream formed after adding the second stream to the exhaust stream should be passed into the porous media before combustion takes place. Finally, at least a portion of the CO, H₂ and CH₄ in the exhaust streamlets is oxidized by passing the combined stream through a porous media that absorbs and then radiates some of the heat generated by the oxidation.

A catalytic burner suitable for performing the above method includes a reformation reactor incorporating a catalyst. A manifold that receives the exhaust stream from the reformation reactor and passes the exhaust stream through a plurality of discharges forming part of the manifold thereby creating a plurality of exhaust streamlets. The exhaust streamlets then enter a flow path where the exhaust streamlets are directed into a proximately located porous media. Means for introducing a second fluid into the flow path are also provided.

The reformation reactor is a partial oxidation reactor. In a partial oxidation reactor, the catalyst and its associated geometry, e.g. substrate and dispersion thereon, defines an activity relative to the flow rate, i.e., residence time, of the methane/oxygen thereover such that when the catalyst and the methane/oxygen interact partial oxidation products and not complete oxidation products are predominantly formed. In the case of methane and oxygen, partial oxidation products are H₂ and CO, while the complete oxidation products are H₂O and CO₂. An example of a reformation reactor for methane suitable for this application is disclosed in U.S. Pat. No. 5,648,582, the disclosure of which is incorporated herein in its entirety.

As those skilled in the art will appreciate, the selectivity, i.e. the ability to produce one product in favor of another, in the reformation process can be manipulated by controlling the temperature of the fluid stream. In the case of a fluid stream including methane and oxygen in fuel rich proportions, preheating of the fluid stream increases the selectivity in the reformation of methane in favor of H₂ and CO versus CO₂ and H₂O. Therefore, an enhancement to the catalytic burner incorporates heating the fuel stream prior to its entry into the reformation reactor.

The exhaust and the second fluid are mixing and reacting inside the porous media to further oxidize at least part of the exhaust stream to the complete oxidation products. The porous media absorbs some of the heat created by the exothermic oxidation reaction and emits it in the form of infrared radiation, assuring that the temperature remains below the adiabatic flame temperature defined by the reactant stoichiometry of the fuel constituents and oxygen. A porous media can be any media through which a gas can flow while continuously encountering solid surfaces. In other words, porous media is comprised of alternating regularly or randomly empty volumes and filled volumes. Empty volumes should form a continuous network such that the porous media remains permeable to permit the flow of a fluid therethrough. The porous media should have a pore size which describes the average size of the empty volume (if the pore is not round, the pore size is the dimension of the smallest side). The pore size should be generally uniform but small deviations are acceptable. Porous media having a few large empty volumes and otherwise generally uniform smaller volumes could be problematic. The precise pore size, porosity (ratio of open volume to total volume), and material are application dependent.

The material for the porous media should be chosen to withstand the temperatures generated in the exothermic oxidation process and effectively emit heat in the form of infrared radiation. Pore size and porosity are chosen large enough to minimize pressure drop induced by the porous media but small enough when compared to the total volume in which the oxidation reaction between the exhaust and the second stream takes place.

As those skilled in combustion will readily appreciate, the reformation reactor requires that the catalyst therein be at a certain temperature to perform the reformation. The catalyst can be brought to this temperature by any one or a combination of well know procedures, such as heating the fluid stream, or direct heating of the catalyst.

Regardless of the method chosen, the exhaust gas will have a temperature upon exiting the catalyst equal to the operational temperature chosen for the reformation reactor plus the exothermal resulting from the exothermic oxidation process taking place therein. It should be remembered that the proportions of fuel constituents to oxygen within the exhaust stream are still quite rich. The initial stream had fuel rich proportions and oxidant was consumed along with fuel creating a progressively richer fuel stream as it passed through the reformation reactor. Therefore, although the fuel constituents in the exhaust gas will be quite hot, oxidation will not occur within the exhaust stream until additional oxidant is added.

Where the fuel/oxygen stoichiometry, flow rate and infrared radiation are such that porous media is hot enough, oxidation of fuel inside the porous media will occur upon contact with an oxidant. Where the porous media is not hot enough to support oxidation on contact with an oxidant, the porous media can utilize a suitable oxidation catalyst to sustain the oxidation reaction. It is understood that a catalyst can be used even if the fuel constituents are hot enough to support combustion.

### DESCRIPTION OF THE DRAWINGS

FIG. 1 is a side view of the catalytic burner of the present invention.

FIG. 2 is a top view of the manifold of the present invention taken along line 2-2 of FIG. 1.

FIG. 3. is a side view of a second embodiment of the catalytic burner of the present invention.

FIG. 4 is a top view of the catalytic burner taken along the line 4-4 of FIG. 3 showing the heat exchanger.

### DETAILED DESCRIPTION

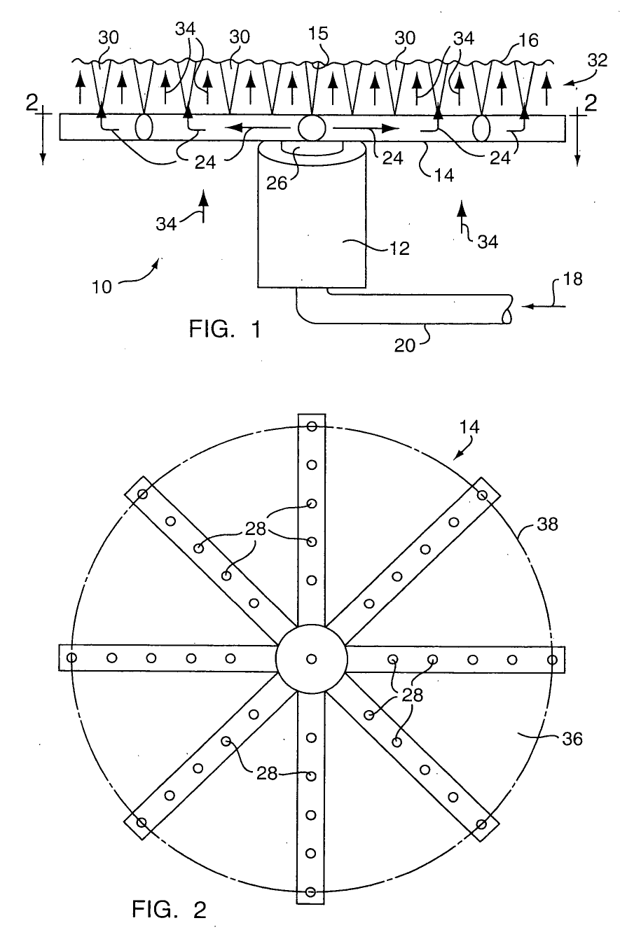

As shown in FIG. 1, the catalytic burner, generally referred to by the reference number 10, is comprised of a reformation reactor 12, a manifold 14 and a porous media 16. An inlet stream 18 enters the reformation reactor 12 by means of a flow path 20 creating an exhaust stream 24. The manifold 14 and reformation reactor 12 are connected by a flow path 26 such that the exhaust stream 24 enters the manifold 14 to exit through a plurality of discharges 28 (See FIG. 2). Exhaust streamlets 30 are formed by the discharges 28. The discharges 28 are positioned proximate the porous media 16, and connected by a flow path 32, such that upon exiting the discharges 28 the exhaust streamlets 30 enter an inlet face 15 of the porous media 16.

An oxidant 34 flows around the manifold 14 permitting the oxidant 34 to flow into the flow path 35 connecting the discharges 28 to the porous media 16. As shown in FIG. 2, the discharges 28 are positioned to disperse uniformly the exhaust stream 24 as exhaust streamlets 30 over a dispersion area 36, defined by a perimeter 38. The hub and spoke design of the manifold 14 assists in distributing the exhaust streamlets 30 uniformly under the porous media 16 across the inlet face 15, but the manifold 14 and discharges 28 therefrom could be of any design, such as port injectors positioned in the housing 12, thus the invention should not be considered limited to the manifold 14 shown.

The flow path 32 and manifold 14 should cooperate to uniformly disperse the oxidant 34 and exhaust stream 24 across the inlet face 15 of the porous media 16. It is a feature of this invention that the oxidant 34 and exhaust streamlets 30 be associated, but not mixed in the flow path 32. Associated means that the exhaust streamlets 30 and oxidant 34 are brought in contact but are not provided sufficient time to inter-defuse, and therefore, the exhaust streamlets 30 and oxidant 34 generally enter the porous media 16 as discrete streams.

In the method of the present invention, the inlet stream 18 has methane and oxygen in fuel rich proportions. Preferably, the oxygen is provided as a constituent of air. If desired, the methane can be provided as a constituent of a blended fuel, such as natural gas. Preferably, the methane and oxygen are highly mixed. The operational parameters of the reformation reactor 12, including the catalyst therein, are selected such that some, or for all practical purposes all, of the methane is converted primarily into CO and H₂ instead of CO₂ and H₂O. This creates an exhaust stream 24 from the reformation reactor 12 having therein at least the fuel constituents CO, and H₂.

The fuel constituents in the exhaust stream 24 define an adiabatic temperature. The exhaust stream 24 is then divided into exhaust streamlets 30. The exhaust streamlets 30 are then associated with additional oxygen, generally as a constituent of air, in fuel lean proportion (exhaust stream to oxygen). It is preferred that exhaust and oxygen are mixed in a proportion close to stoichiometric with small excess oxygen. The exhaust streamlets 30 and additional oxygen then pass into the porous media 16 where mixing and oxidation, which is exothermic, takes place. The porous media 16 is constructed of materials that absorb some of the heat of reaction, such that the oxidation occurring in the porous media 16 is below the adiabatic temperature of the fuel constituents. The heat of reaction absorbed by the porous media 16 is radiated therefrom in the form of infrared radiation.

As discussed above and shown in FIGS. 1 and 2, the catalytic burner 10 has a plurality of discharges 28 that divide the exhaust stream 24 into exhaust streamlets 30. In the context of the method, the exhaust stream 24, which is in fuel rich proportion, has associated with it a certain amount of energy. The energy density of the exhaust stream is proportional to the amount of fuel passing through a certain cross-sectional area per unit of time, i.e. to the volumetric flow rate of the exhaust stream 24. U.S. Pat. No. 5,648,582 suggests that one essential feature of the reformation reactor 12 is that the inlet stream 18 enters the reactor at very high space velocity and the reformation reaction occurs at short residence time. This provides that flow space velocity and associated energy density in the exhaust stream 24 will also be high. If the exhaust stream 24 were to be exposed to additional oxidant as a single stream, excessive amount of heat, associated with the oxidation reaction, would be released in a small volume of the porous media 16. This excessive heat could cause deterioration, or failure, of the porous media 16. The manifold 14 distributes the exhaust stream 24 over the larger cross-sectional area, effectively decreasing the energy density in the stream. The energy density associated with individual exhaust streamlets 30 and any diffusion flame that may be associated therewith is considerably lower and may be adjusted depending on the application. The discharges 28 can also act as diffusers to reduce further the power density, i.e., power per area, of the exhaust stream 24.

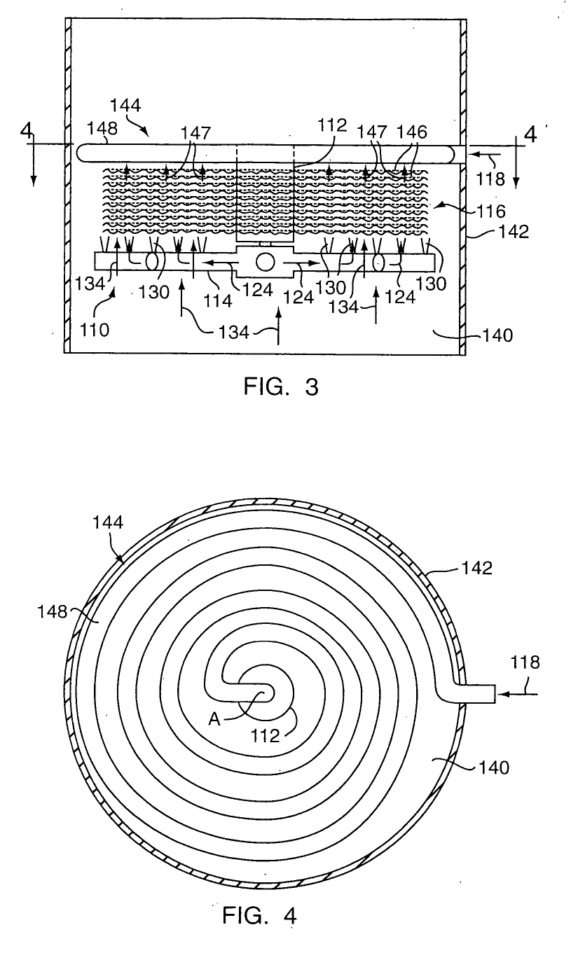

FIG. 3 is a second embodiment of the catalytic burner which is similar to the previous embodiment, therefore, like reference numbers preceded by the number 1 are used to indicate like elements. In this embodiment, the catalytic burner 110 is positioned in an interior area 140 of a housing 142. Also positioned within the interior area 140 is a heat exchanger 144. The reformation reactor 112 is positioned within the porous media 116 as opposed to under it. In this embodiment, the inlet stream 118 enters a heat exchanger 144 positioned within the interior area 140 adjacent the porous media 116. The porous media 116 has a catalyst 146 deposited on the surface thereof. The catalyst 146 is selected to support the continued oxidation of the H₂, CO and CH₄ in the exhaust streamlets 130. The inlet stream 118 flows through the heat exchanger 144 prior to entering the reformation reactor 112.

As explained above, in the method of the present invention an oxidation reaction occurs in the porous media 116. As such, some of the heat of reaction 147 leaves the porous media 116 and is conducted into contact with heat exchanger 144, where some of the heat of reaction is transferred into the inlet stream 118 flowing therein. Referring to FIG. 4, the heat exchanger 144 is comprised of a tube 148 that has been formed into a flat coil about a center point on an axis designated by the letter A.

The heat exchanger 144 could be of any other design, which allows part of heat released in porous media 116 to be transferred into the inlet stream 118, thus, the invention should not be considered limited to the heat exchanger 144 shown.

Continuing with FIG. 3, the manifold 114 is adapted to receive the exhaust streamlets 130 formed from exhaust stream 124 passing from the reformation reactor 112. In this embodiment, the means for introducing additional oxidant 134 between the discharges 128 and the porous media 116 is by the introduction of additional oxidant 134 into the housing 142 below the discharges 128. Depending upon the method of operation, the flow of additional oxidant 134 may be by natural convection or a pump, such as a fan. In most cases, the introduction point is not critical as oxygen as a constituent of air will be the oxidant 134 and the air will naturally flow to the desired location. Therefore, the means could include passages in the housing, or the additional oxidant 134 could flow from a point above the porous media 116 into the housing 142.

In this embodiment, the reformation reactor 112 is shown positioned within the porous media 116. This is not a requirement of the invention, as the reformation reactor 112 could be positioned anywhere including outside the interior area 140.

This embodiment of the present invention is designed to provide the additional step of preheating of the inlet gas stream 118 using some of the heat of reaction produced by the exothermic reaction in the porous media 116. Preheating the inlet stream 118 offers the advantage of increasing the selectively to CO and H₂ within the reformation reactor 112. This is but one method of preheating, therefore the invention should not be considered so limited. Preheating of the inlet stream 118 by other means such as electric resistance is considered within the scope of the invention. Preheating of the inlet stream can assist in starting the catalytic burner.

The porous media 16, 116 is a media through which a gas can flow. In the preferred embodiment, the porous media 16, 116 was made from a plurality of stacked short-channel screens. The invention should not be considered so limited however, as other media could be used such as pellets, foams or gauzes and even a single screen. Generally, porous media are graded by “pore size.” Another important parameter for this invention, however, is consistency of pore size. The porous media 16, 116 is designed to promote interaction of the fuel constituents within the exhaust stream 24, 124 with the additional oxidant 34, 134, extract heat from the ongoing oxidation, and radiate infrared radiation. Further, the porous media 16, 116 continually assures that the exhaust stream 24, 124 and oxidant 34, 134 are divided into small pockets. In other words, the exhaust stream 24, 124 and oxidant 34, 134 cannot reform into a large volume. These requirements mean that preferably the pores within the porous media 16, 116 are generally uniform. Pore size is chosen such that the pores are large enough to minimize pressure drop but small enough to assure an acceptable heat release within a pore.

Although the present invention has been described in considerable detail with reference to certain preferred versions thereof, other versions are possible, particularly versions having more than two catalysts. Therefore, the spirit and scope of the invention should not be limited to the description of the preferred versions contained herein.

What is claimed is:

1. A catalytic burner comprising:
a) a reformation reactor having a catalyst therein suitable for the converting of at least a portion of the methane in the fuel stream including methane and oxygen in fuel rich proportions to carbon monoxide and hydrogen for creating an exhaust stream;
b) a manifold having a plurality of discharges, the manifold in fluid communication with the exhaust stream and defining a plurality discharges;
c) a porous media:
d) means defining a flow path between at least some of the discharges and the porous media; and
e) means for introducing oxygen into the flow path such that the exhaust stream and oxygen are in fuel lean proportions.

2. The catalytic burner of claim 1 wherein the porous media is a plurality of stacked short-channel screens.

3. The catalytic burner of claim 1 wherein the porous media has a catalyst positioned on the surface thereof.

4. The catalytic burner of claim 1 further comprising a heat exchanger, downstream of the porous media for receiving and passing the fuel therethrough.

5. The catalytic burner of claim 2 wherein the heat exchanger is a spiral shape tube.

6. The catalytic burner of claim 1 wherein the manifold includes a hub having a plurality of spokes extending therefrom.

7. The catalytic burner of claim 1 wherein at least a portion of the reformation reactor is positioned within the porous media.

8. A catalytic burner comprising:
a) a reformation reactor for reforming an inlet stream;
b) a manifold having a plurality of discharges;
c) means defining a first flow path between the reformation reactor and the manifold;
d) a porous media;
e) means for defining a second flow path between at least some of the discharges and the porous media; and
f) means for introducing oxidant into the second flow path.

9. The catalytic burner of claim 8 wherein the porous media is a plurality of stacked short-channel screens.

10. The catalytic burner of claim 8 wherein the porous media has a catalyst positioned on the surface thereof.

11. The catalytic burner of claim 8 further comprising a heat exchanger located downstream of the porous media.

12. The catalytic burner of claim 11 wherein the heat exchanger is a spiral shape tube.

13. The catalytic burner of claim 8 wherein the manifold a hub having a plurality of spokes extending therefrom.

14. The catalytic burner of claim 8 wherein at least a portion of the reformation reactor is positioned within the porous media.
